(19) United States
(12) Patent Application Publication
(10) Pub. No.: US 2017/0320202 A1
(43) Pub. Date: Nov. 9, 2017

(54) STUB AXLE REMOVAL DEVICE

(71) Applicant: Tom Mecham, Williston, ND (US)

(72) Inventor: Tom Mecham, Williston, ND (US)

(21) Appl. No.: 15/149,264

(22) Filed: May 9, 2016

(51) Int. Cl. B25B 27/02

(52) U.S. Cl. CPC B25B 27/023

(57) ABSTRACT

A stub axle removal tool is attached to a stub axle or wheel using a flange and bolts. The flange is attached to a threaded rod that is braced against the vehicle's body to prevent unintended movement of the rod during the procedure. By rotating the threaded rod relative to the brace, the rod, flange, and attached stub axle move axially to remove the stub axle from the vehicle's differential.

### BRIEF DESCRIPTION OF THE FIGURES

FIG. 1 is a schematic representation depicting a perspective view of one preferred embodiment of the invention.

FIG. 2 is a schematic representation depicting a depicting a perspective view of one preferred embodiment of the invention in conjunction with a brace and vehicle frame.

FIG. 3 is a schematic representation depicting one preferred embodiment of the invention in use with a stub axle.

FIG. 4 is a schematic representation depicting an end view of the flange of one preferred embodiment of the invention.

### DESCRIPTION OF THE PREFERRED EMBODIMENTS

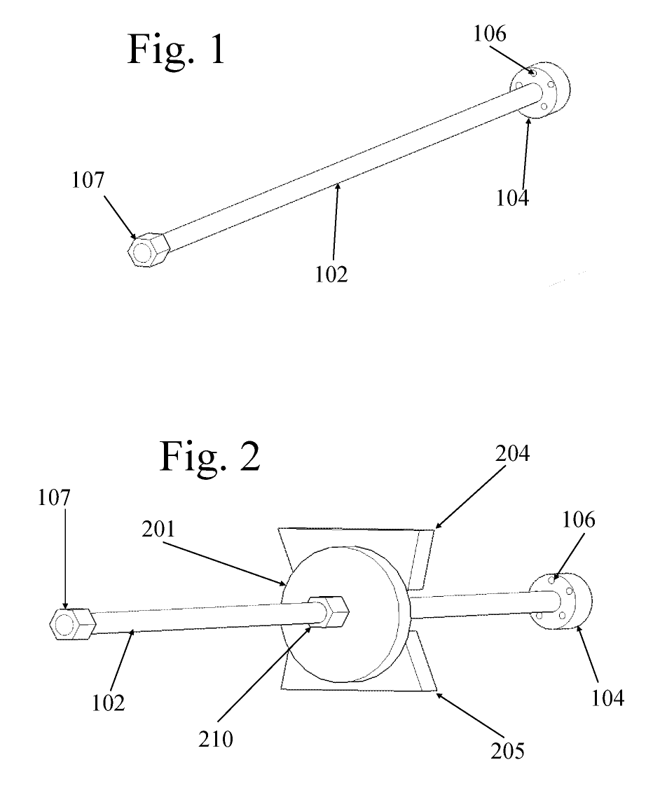

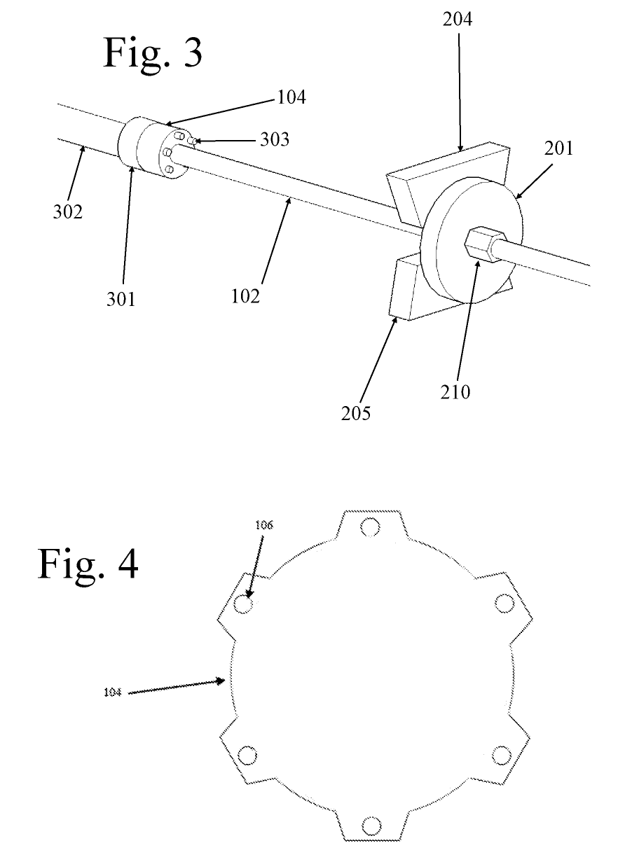

As shown in FIG. 1, the stub axle puller of one preferred embodiment includes a rod 102 having an at least partially threaded surface, a flange 104 fixed to one end of rod 102, a plurality of holes 106 within flange 104, and a terminal nut 107. As shown in FIG. 3, the flange 106 may be coupled to a wheel 301 and stub axle 302 using bolts 303 (through holes 106). The rod is positioned within a brace 201 and nut 210 allowing the rod 102 to be rotated relative to brace 201 to create linear movement of rod 102 along its longitudinal axis to remove the stub axle 302 from a vehicle differential. The brace 201 may be positioned against a vehicle frame component, such as portions 204 and/or 205, preventing unwanted movement in other directions.

The following are descriptions of exemplary embodiments of the invention intended to enable a person skilled in the prior art to make and use the invention. Other embodiments of the present invention are also possible and would be understood by such a person based on this specification. Nothing in these descriptions should be interpreted as limiting the scope of the invention, as there are a wide variety of materials, parts, and methods in the art that are understood to be interchangeable with those listed herein.

The wheels of a vehicle may be attached by a single axle that runs across the full width of the vehicle's body, or a wheel may be attached to a shorter, so-called “stub” axle. The stub axle is mounted within the differential of the vehicle. In performing vehicle maintenance, it is sometimes necessary or desirable to remove the stub axle from the differential. In the prior art, in order to remove a stub axle from the differential, the differential assembly must be removed from the vehicle. Removing the differential is time consuming and labor-intensive, making it desirable to have a way to remove the stub axle without removing the differential from the vehicle. The present invention allows a person to remove a stub axle from the differential without having to completely remove the differential from the vehicle.

FIG. 1 is a perspective view of one embodiment of the invention. This embodiment comprises a flange 104 positioned at one end of a rod 102. The flange includes a number of holes 106 positioned radially along its perimeter (or at other predetermined points within the flange surface). In this embodiment, the holes 106 are of an appropriate size and are positioned such that the flange 104 may be bolted to a wheel assembly or stub axle assembly having five equally spaced bolts. The arrangement of holes 106 on flange 104 is determined by the stub axle bolt pattern with which the remover is intended to couple. The flange 104 attached firmly to rod 102, or they may be a single component. Rod 102 may also have a terminal nut 107 at the other end, which is also fixed to rod 102. Terminal nut 107 may be used to apply torque to rod 102 to create rotational movement.

As shown in FIG. 2, the rod 105, terminal nut 107, and flange 104 assembly may be used in conjunction with a brace 201 and tension nut 210. Tension nut 210 may be fixedly attached to brace 201 or may be held in place relative to brace 201 during operation. This allows the operator to turn rod 102, for example by rotating terminal nut 107, relative to nut 210 and brace 201.

Brace 201 may be positioned against portions of the car frame 204 and 205. When brace 201 and terminal nut 210 are held in place relative to car frame portion 204 and 205, rotating nut 107 and rod 102 causes the rod 102 to move along its longitudinal axis perpendicular to brace 201. The flange 104, attached to rod 102, will rotate and move as well.

FIG. 3 shows the assembly in place and coupled to a stub axle for removal. As discussed above with respect to FIGS. 1 and 2, rod 102 is threaded through nut 210 and brace 201. Brace 201 is placed against car frame portions 204 and 205 in order to hold rod 102 in place along its longitudinal axis. The flange 104, attached to rod 102, is coupled to wheel 301 via bolts 303. Wheel 301 is, in turn, coupled to stub axle 302.

When rod 102 is rotated relative to nut 210 and brace 201, it moves along its longitudinal axis in a direction away from wheel 303. This rotation and movement affect rod 102, flange 104, wheel 301, and stub axle 302. This allows an operator to pull the stub axle 302 out smoothly along its own axis within tight constraints in and around the vehicle differential.

Rod 102 may be comprised of a single threaded piece, or it may be comprised of several pieces that are assembled into the final rod 102. In the latter case, for example, rod 102 may be comprised of two rod pieces that are screwed into each other. By using a single piece, rod 102 may be made to withstand a larger amount of torque or strain, while using multiple pieces would allow rod 102 to be transported or stored easily. The particular form of rod 102 should be determined by the needs of a given embodiment.

FIG. 4 shows one embodiment of flange 104 and holes 106 designed for a stub axle on Chevrolet cars and trucks, but alternative embodiments are possible for other makes or models. By adjusting the position and number of holes 106 on the flange 104, the invention would be appropriate for other stub axle designs.

The above descriptions are only examples and are not intended to be limitations of the inventions. In other embodiments, for example, brace 201 may be attached to the frame with a vise or clamp. In still other embodiments, a thrust bearing and/or washer assembly may be used in conjunction with the brace 201 to better permit operation of the assembly. In still other embodiments, the rod may be coupled to a hydraulic element internal or external to rod 102. In practice, any actuator that is capable of creating linear motion of rod 102 along its longitudinal axis is appropriate for use in this invention.

I claim:

1. A stub axle remover comprising:
a rod comprising a threaded surface;
a brace capable of engaging with a surface of a vehicle, said brace having a central opening with a threaded interior surface;
a flange affixed to a first end of the rod;
said flange comprising a plurality radially spaced holes adapted to attach to the bolt pattern of a stub axle;
wherein the rod being positioned through the central opening of the brace and the threaded surface of the rod is engaged with the thread interior surface of the central opening;
wherein relative rotation of the rod relative to the brace causes the flange to move along the longitudinal axis of the rod.

2. The stub axle remover of claim 1, wherein the holes are configured to align with the bolts on a stub axle suitable for use with a Chevrolet automobile.

3. The stub axle remover of claim 1, wherein the holes are arranged as the vertices of a regular polygon.

4. The stub axle remover of claim 3, wherein the plurality of elements is configured to attach to the bolt pattern of a wheel.

5. The stub axle remover of claim 1, wherein the flange is affixed to the rod using a coupler.

6. The stub axle remover of claim 6, wherein the coupler is a truncated cone in shape.

7. The stub axle remover of claim 1, further comprising a nut affixed to the threaded rod and the brace.

8. The stub axle remover of claim 1, wherein the brace is configured to engage a portion of a vehicle to restrict movement of the rod along at least one axis.

9. The stub axle remover of claim 8, wherein the bracing element engages the portion of the vehicle using friction.

10. A stub axle remover comprising:
a rod comprising a threaded surface;
a brace capable of engaging with a surface of a vehicle;
a nut fixed relative to the brace and having a central opening with a threaded interior surface;
a flange affixed to a first end of the rod;
said flange comprising a plurality of radially spaced holes adapted to attach to the bolt pattern of a stub axle;
wherein the rod being positioned through the central opening of the nut and the threaded surface of the rod is engaged with the thread interior surface of the central opening;
wherein relative rotation of the rod relative to the brace causes the flange to move along the longitudinal axis of the rod.

11. A stub axle remover comprising:
a rod positioned through the central opening of a brace configured to substantially limit the rod's movement to its longitudinal axis;
a flange affixed to a first end of the rod;
said flange comprising a plurality radially spaced holes adapted to attach to the bolt pattern of a stub axle;
a hydraulic actuator coupled to the rod such that activating the actuator causes the rod to move along its longitudinal axis.
